(19) United States
(12) Patent Application Publication
(10) Pub. No.: US 2025/0083259 A1
(43) Pub. Date: Mar. 13, 2025

(54) LASER CUTTING MECHANISM AND METHOD FOR MANUFACTURE OF AN ELECTRODE

(71) Applicant: Solid Power Operating, Inc., Louisville, CO (US)

(72) Inventors: David A. TELEP, Longmont, CO (US); Uday KASAVAJJULA, Superior, CO (US)

(21) Appl. No.: 18/882,321

(22) Filed: Sep. 11, 2024

Related U.S. Application Data
(60) Provisional application No. 63/537,748, filed on Sep. 11, 2023.

(51) Int. Cl. B23K 26/38; B23K 26/0622; B23K 26/142; B23K 101/36

(52) U.S. Cl. CPC B23K 26/38; B23K 26/0622; B23K 26/142; B23K 2101/36

(57) ABSTRACT

Systems and methods of using a laser cutting device to cut an electrode laminate for a battery. The laser cutter may super heat and volatilize the various components of the layers of the electrode stack. The laser cutter may be programmed or otherwise controlled to direct its laser to cut the electrode stack into any shape. Further, as the laser cutter super heats the materials within the layer(s), the material may volatilize or ablate and be removed from the environment with simple vacuum systems, thereby reducing or eliminating metal shards and other contaminants that may be generated through conventional cutting procedures that damage or short-circuit the electrode. This “cauterization” process may also generate a unique pattern or composition of oxides and hydroxides of the electrode that is identifiable through a chemical mapping process to uniquely identify, or “fingerprint”, the electrode based on the chemical make-up of the cut electrode stack.

### CROSS-REFERENCE TO RELATED APPLICATIONS

This application is related to and claims priority under 35 U.S.C. § 119 (e) from U.S. Patent Application No. 63/537,748 filed Sep. 11, 2023, titled “Laser Cutting Mechanism and Method for Manufacture of an Electrode,” the entire contents of which is incorporated herein by reference for all purposes.

### TECHNICAL FIELD

Various embodiments described herein relate to the field of solid-state primary and secondary electrochemical cells, electrodes, and electrode materials, and the corresponding methods of making and using the same.

### BACKGROUND AND INTRODUCTION

The ever-increasing number and diversity of hybrid/electric automobiles, among other things, is driving innovations in battery technologies to improve reliability, capacity, thermal characteristics, lifetime and recharge performance. Currently, although lithium solid-state battery technologies offer potential increases in safety, packaging efficiency, and enable new high-energy chemistries as compared to other types of batteries, improvements in battery technologies generally and particularly solid-state battery technologies are needed, including improvements in production efficiency.

It is with these observations in mind, among others, that various aspects of the present disclosure were conceived.

### SUMMARY

One aspect of the present disclosure relates to method for cutting a battery electrode. The method may include the operations of laminating an electrode stack comprising a plurality of layers using a pressing device, wherein the pressing device laminates a solid-state electrolyte (SSE)-containing layer to a conductive foil and removing, using a laser cutting device, a portion of the electrode stack.

Another aspect of the present disclosure relates to a system for manufacturing an electrode of a battery. The system may include a pressing device laminating an electrode stack comprising a solid-state electrolyte (SSE)-containing layer to a conductive foil and a laser cutting device generating a laser to cut a portion of the electrode stack into a shaped electrode for the battery.

### BRIEF DESCRIPTION OF THE DRAWINGS

FIGS. 1A-1B are diagrams illustrating a solid-state electrode and a single solid-state battery cell, according to aspects of the present disclosure.

FIG. 2 is a diagram illustrating manufacturing a solid-state electrode laminate using a calendar press and a laser cutting device, according to aspects of the present disclosure.

FIG. 3 is a flowchart of a method for manufacturing a solid-state electrode laminate, according to aspects of the present disclosure.

FIG. 4 is a diagram of a laser cutting device for cutting a solid-state electrode laminate, according to aspects of the present disclosure.

FIG. 5 is an overhead view of a laser cut electrode, according to aspects of the present disclosure.

FIG. 6 is a diagram of a laser cut solid-state electrode with a cauterized cut edge with increased amount of oxygen near the laser cut edge, according to aspects of the present disclosure.

FIG. 7 is a diagram illustrating an example of a computing system which may be used in implementing embodiments of the present disclosure.

### DETAILED DESCRIPTION

Lithium-based rechargeable batteries are used to power many forms of modern electronics and have the capability to serve as the power source for hybrid and fully electric vehicles among many other uses. State-of-the-art lithium-based rechargeable batteries typically employ a carbon-based anode to store lithium ions, such as a graphite anode. In these anodes, lithium ions are stored by intercalating between planes of carbon atoms that comprise graphite particles. Cathodes of such rechargeable batteries may contain transition metal ions, such as nickel, cobalt, and aluminum, among others. Such electrodes have been tailored to confer acceptable performance in modern lithium-ion batteries. However, carbon-based anodes are reaching maturity in terms of their lithium-ion storage.

Traditionally, in a solid-state battery cell, there are three segments of the battery: anode (or negative electrode), separator (solid electrolyte layer), and cathode (or positive electrode). To form the anode and cathode layers, an active material may be combined with an electrically conductive additive (e.g., carbon), one or more binders, in some cases a solid electrolyte material, and one or more processing solvents. These materials are mixed together to form a homogeneous composite which is coated/cast onto a metal foil, which may serve as a current collector in the finished cell. The combined composite and coating may then be dried to form the electrode layer(s).

The term “battery” in the art and herein can be used in various ways and may refer to an individual cell having an anode and cathode separated by an electrolyte, solid or liquid, as well as a collection of such cells connected in various arrangements. A battery or battery cell is a form of electrochemical device. Batteries generally comprise repeating units of sources of a countercharge and electrode layers separated by an ionically conductive barrier, often a liquid or polymer membrane saturated with an electrolyte. These layers are made to be thin so multiple units can occupy the volume of a battery cell, increasing the available power of the battery cell with each stacked unit. Although many examples are discussed herein as applicable to a battery cell, it should be appreciated that the systems and methods described may apply to many different types of batteries ranging from an individual cell to batteries involving different possible interconnections of cells, such as cells coupled in parallel, series, and parallel and series. For example, the systems and methods discussed herein may apply to a battery pack comprising numerous cells arranged to provide a defined pack voltage, output current, and/or capacity. Moreover, the implementations discussed herein may apply to different types of electrochemical devices such as various different types of batteries and solid-state batteries of various possible chemistries, to name a few. The various implementations discussed herein may also apply to different structural battery cell arrangements such as button or “coin” type batteries, cylindrical battery cells, pouch battery cells, and prismatic battery cells.

To manufacture a solid-state graphite anode, for example, some methods involve a graphite slurry that includes the graphite components, binders, and solvent, which are applied to a current collector metal foil, such as a copper foil, by a process of extrusion, rolling, or tape-casting, depending on selected process and solvents used. After application, the coated graphite mixture is dried by evaporation of solvents, such as by running the coated slurry through an oven or other drying machine. Cathode (also considered an electrode) construction may occur in a similar manner, perhaps with an aluminum foil used.

Once dried, an electrode is generally cut into shape for a battery configuration by a mechanical cutting device. For example, a die cut or stamping device may be used to mechanically cut or stamp out the final electrode shape from a strip of electrode material. Other mechanical cutting devices that are used include rotary blades, scissors, etc. However, such mechanical cutting devices may introduce flaws in the electrode layers, resulting in a shorter battery life or a potential for a short occurring within the battery itself. For example, a shearing action from a die cut or scissor cutting device may create tearing or roughing of the delicate layers of the electrode. In another example, the pinching force from a cutting device may cause separation of some layers of the electrode, undoing or lessening the adhesion between the layers. In still another example, some mechanical cutting devices may liberate metal shavings or other particles from the layers of the electrode and reapply those particles onto other layers in circumstances in which separation of the layers is needed for proper battery operation. Rather, redistribution of the particles of the layers of the electrode may cause shorts to occur in the electrode, alter the chemical composition of portions of some layers, or otherwise cause negative effects within the electrode that may damage a battery configuration.

It is with these observations in mind, among other, that aspects of the present disclosure were conceived.

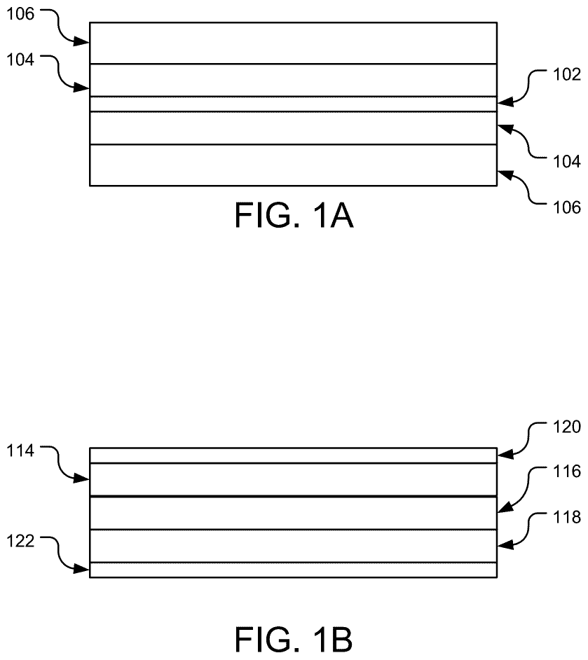

Aspects of the present disclosure involve systems and methods of producing an electrode laminate for a battery, which may also include a solid-state electrolyte separator layer that may replace a distinct separator layer and liquid electrolyte used in conventional liquid electrolyte battery architectures. The composition of the electrode may take many forms. For example, an anode electrode, as illustrated in FIG. 1A, may comprise a stack of a current collector layer 102, an electrode layer 104 on one or both sides of the current collector layer, and an outer solid-state electrolyte (SSE) layer 106 on one or both of the electrode layers. In some instances, the electrode layer 104 and/or the SSE layer 106 may be prepared in a slurry form that includes a binder solution and/or a solvent. For example, the binder material included in the electrode and/or SSE slurry may be polymer-based binders, such as but not limited to, polystyrene, ethylene butyl acrylate (EBA), and the like. As noted above, the electrode slurry 104 may be coated onto the current collector 102 on one or both sides of the layer and the SSE slurry may be coated onto the outer side of the electrode layer 104 (opposite the current collector 102). The entire stack may be dried to set and adhere the slurry layers to the current collector 102. A cathode electrode may be constructed in a similar manner to form a cathode electrode stack.

The anode and the cathode electrodes may be combined into many configurations to create a battery. For example, FIG. 1B illustrates a single battery cell that includes an anode layer 114 and a cathode layer 118, separated by an SSE layer 116. A first current collector layer 120 may be adjacent the anode layer 114 and a second current collector layer 122 may be adjacent the cathode layer 118. Other configurations of the anode electrode and the cathode electrode and the solid-state electrolyte layer are also contemplated. For example, an SSE layer 116 may be located on both sides of the anode 114 and/or the cathode 118, in some implementations. Still other configurations are possible. A finished battery, which may be encapsulated in a pouch, may have one or more battery cell arrangements.

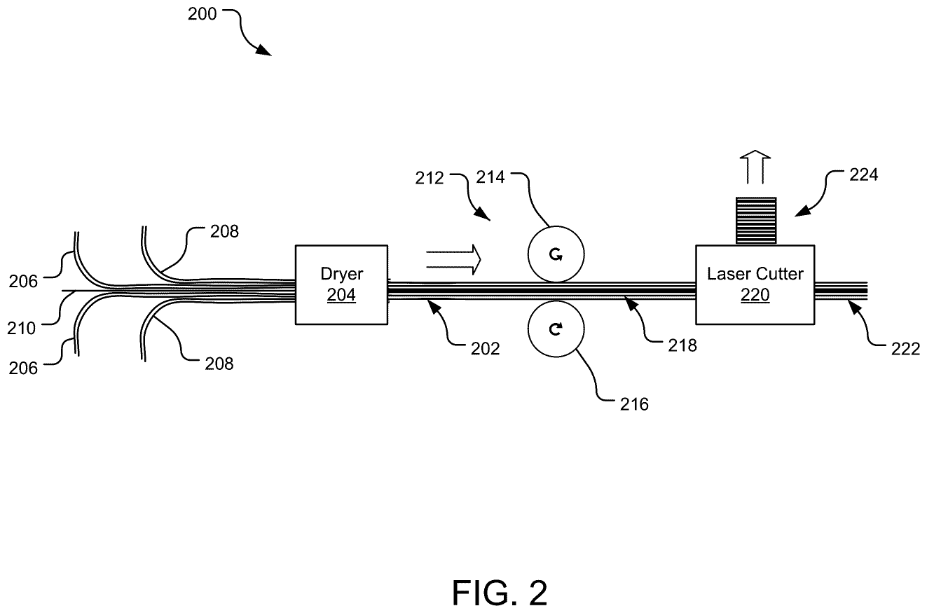

FIG. 2 is a diagram 200 illustrating manufacturing a solid-state electrode laminate 202 using a calendar press device 212 and a laser cutting device 220, according to aspects of the present disclosure. In one implementation, the solid-state electrode 202 may include, as described above, a current collector layer 210 with two electrode layers 206 of a composite slurry blend coated onto both sides of the current collector such that the electrode layers are facing each other with the current collector metal layer between the two electrode layers. Further, two SSE layers 208 may be coated onto the outer surface of the electrode layers 206 in an SSE-Electrode-Current Collector-Electrode-SSE stack configuration. The composite SSE layers 208 in this configuration may conduct ions during use in a battery such that the SSE layers provide electrical isolation for the metal electrode layer 206. Following application of the slurry layers 206, 208, the stack of layers may be dried by dryer 204 to set and adhere the slurry layers to the current collector layer 210.

Following drying, the stack 202 may be laminated and/or densified by a calendar press device 212 comprising a first roller 214 and a second roller 216. The rollers 214, 216 exert a compressive force on the stack 202 to press the layers together reducing the porosity of one or more of the materials within the stack (otherwise known as densifying), enhancing material contact, and causing layers to laminate or otherwise bond. The pressure applied to the stack 202 may correlate to a spacing between the first roller 214 and the second roller 216, among other factors such as temperature of the stack, which may be adjustable by a controller. For example, one or both of the calendar rollers of the press 212 may be adjustable to increase or decrease the spacing between the rollers 214, 216. This densification of the stack 202 may cause the SSE layers 208 to press into the conductive layer 210 and generate adhesion between the layers. The pressure exerted by the calendar rollers on the stack may be adjusted by adjusting the space between the calendar rollers, either manually or automatically in a sensed feedback loop with a controller, based on a variety of possible factors such as the density and type of material of the stack, the pre-densified thickness of the layers of the stack, and the like.

In some embodiments and after calendaring, the dried electrode stack 218 may be fed through a laser cutting device 220 to cut the electrode into a shape for use in a battery configuration. Conventional methods used to cut such layers involve punching or shearing techniques, such as die punching or scissors. However, these devices may produce the intended cutting effect by means of metal-on-metal or metal-on-material contact, which can produce fine metallic particles or tiny crushed fragments of various battery components. These liberated fine particles can contaminate exposed surfaces of the layers and otherwise, which can cause reduce electrochemical performance and may introduce impurities that would have other negative effects, such as introducing a short circuit path, during operation of the electrochemical cell. Mechanical cutting may also deform the edges along the cut lines into the stack, which may alter spacing or inadvertently create unintended contact points. Other damage to the layers of the electrode stack 218 may also occur due to the pinching or shearing action of various cutting devices. To address these issues, a laser cutting device 220 can be used to cut through the various layers.

As such, aspects of the present disclosure involve systems and methods of using a laser cutting device 220 to cut an electrode laminate for a battery. The laser cutter 220 (such as fiber laser cutters, CO2 lasers, direct diode lasers, etc.) may, in some instances, through application of the laser, super heat and volatilize the various components of the layers of the electrode stack 218, such as the current collector layer 210, electrode layer 206, and the SSE layer 208. In some instances, the laser cutter 220 may be programmed or otherwise controlled to direct its laser to cut the electrode stack 218 into any shape. Further, as the laser cutter 220 super heats the materials within the layer(s), the material may volatilize or ablate and be removed from the environment with simple vacuum systems, thereby reducing or eliminating metal shards and other contaminants that may be generated through conventional cutting procedures that damage or short-circuit the electrode. Further still, many SSE layers 208 contain a sulfide electrolyte that, when heated via the laser, may decompose releasing sulfur. This released sulfur may react with the other heated elements, such as an aluminum or copper current collectors, producing such materials as aluminum sulfide (Al₂S₃) or copper sulfide (CuS). These sulfides may fully or partially decompose into the respective oxides or hydroxides that may fully or partially coat the newly cut surface, protecting the cut edge from reacting with ambient air or moisture that degrade the conductive quality of the electrode edge. This “cauterization” process may also generate a unique pattern or composition of such oxides and hydroxides of the electrode that is identifiable through a chemical mapping process to uniquely identify, or “fingerprint”, the electrode based on the chemical make-up of the cut electrode stack 218. This fingerprint of chemical make-up may also extend from the cut edge toward the center of the electrode. For example, the electrolyte material of the cut electrode stack 218 that is within close proximity of the heated cut areas due to the laser cutting may fully or partially decompose, while areas away from the heated cut may be less decomposed comparatively. Thus, the laser cutting may create a gradient of electrolyte phases from the cut edge of the electrode stack 218 toward the center of the piece that may further be unique to the particular electrode stack for identification purposes.

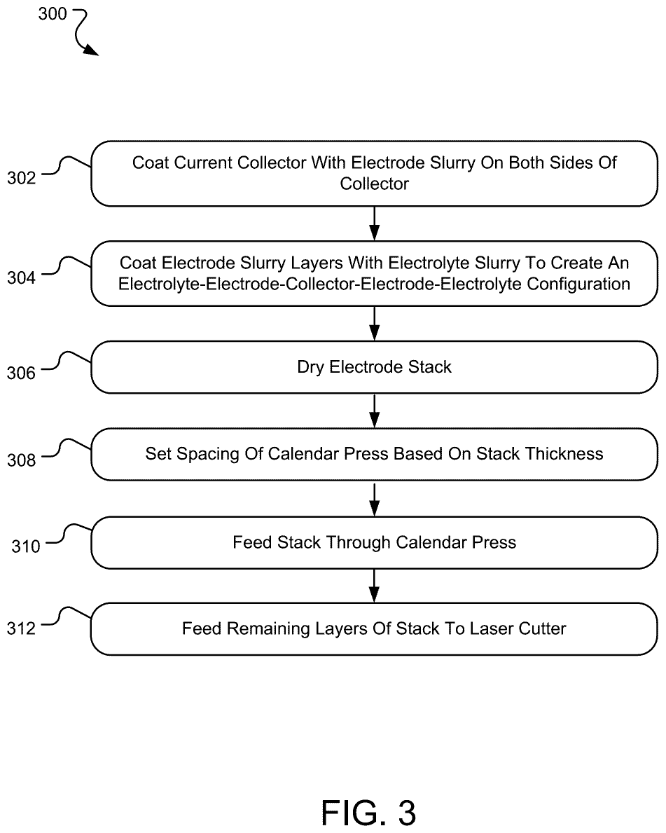

FIG. 3 is a flowchart of a method 300 for manufacturing a solid-state electrode laminate, according to aspects of the present disclosure. Beginning at step 302, an electrode slurry 206 may be cast onto a metal foil current collector 210, as described above. In one implementation, the metal foil may be an aluminum foil, although other types of foils may be used. In some implementations, the electrode slurry 206 may be cast onto both sides of the current collector 210. In other implementations, however, the electrode may be cast on only one side of the current collector. At step 304, an electrolyte slurry 208 may be cast onto both electrode layers 206, as also described above. For the implementation in which the electrode layer 206 is cast on only one side of the current collector 210, the electrolyte slurry is cast onto the side of the electrode layer opposite the current collector 210.

Regardless of the configuration, the layers of the electrode stack may pass through a dryer 204 at step 306 to set and adhere the slurry layers to each other and the current collector 210. Once dried, the stacked configuration 202 may be fed through a calendar press 212 to laminate the layers together and densify the layers. Thus, at step 308, a spacing of the calendar press 212 may be set. In one implementation, the spacing may be manually set by an operator of the press. In another implementation, the spacing may be controlled by a calendar press controller based on one or more inputs. Further, the spacing of the calendar press 212 may be based on the thickness of the stack 202 of materials or on the thickness of any or more of the layers of the stack. At step 310 and following the setting of the spacing of the press 212, the stack 202 may be fed through the calendar press for laminating the layers of the stack.

At step 312, the calendared electrode stack 202 may be fed into a cutter device 220 for cutting into appropriate lengths or shapes for use in a battery configuration. In one implementation, the cutter device 220 may include a laser that super heats the layers to cut the electrode into an intended shape for a battery configuration. As shown in FIG. 2, the laser cut electrodes 24 may exit the cutter 220 in a stacked formation, although the electrodes may be removed from the cutter device through any technique. Following the cutting of a first electrode, the stack 218 may then be fed through the cutter into a position in which a second electrode may be cut, and so on. In this manner, multiple electrodes may be cut from laminated electrode stack 218 discussed above for use in multiple battery cells. The remaining portion 222 of the stack 218 following cutting may be recycled or discarded, while the cut portions 224 may be used within one or more battery configurations.

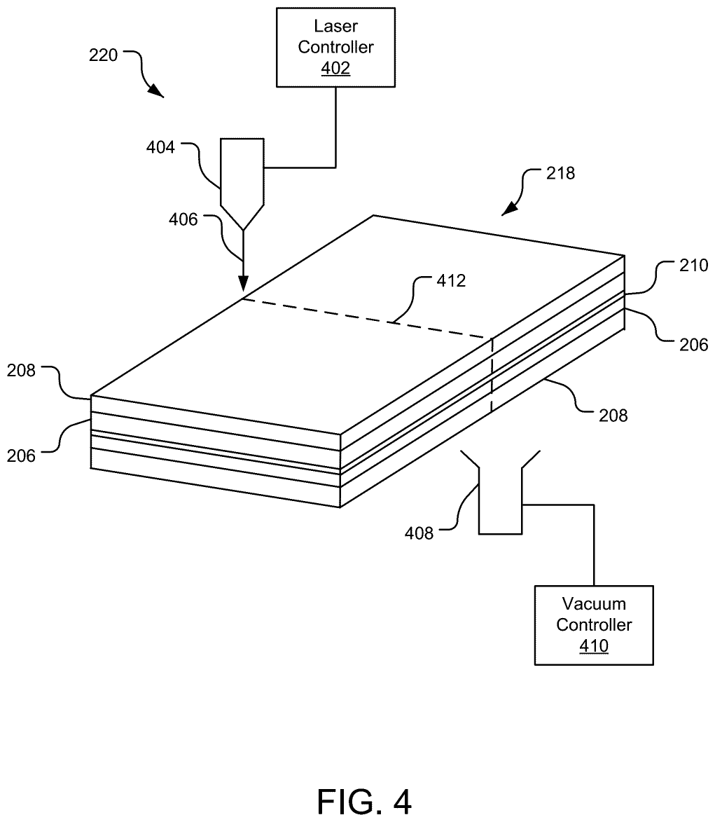

FIG. 4 is a diagram of a laser cutting device 220 for cutting a solid-state electrode stack 218. As discussed above, the electrode stack 218 may include one or more SSE layers 208, one or more electrode layers 206, and one or more current collector layers 210. In one particular implementation, the electrode stack 218 may have an SSE-electrode-current collector-electrode-SSE configuration, although other configurations are contemplated for use with the laser cutter 220. The laser cutter 220 may be controllable to cut through the layers of the electrode stack 218, such as along cut line 412. In particular, the laser cutter 220 may include a laser generator 404 that produces a laser beam 406 directed at the outer SSE layer 206. The laser beam 406 may generate a heat at the surface and through the electrode stack 218 to volatilize the various components of the layers to cut through the electrode.

The laser generator 404 may be controllable to generate a laser beam 406 to cut through the electrode stack 218 without causing any additional damage to the layers of the stack. In one implementation, a laser cutter controller 402 may be in communication with the laser generator 404 to control the operation of the generator and/or the laser beam 406. The laser generator 404 may be instructed to optimize several aspects of the laser beam 406 by the controller 402. For example, the laser generator 404 may be instructed, by the controller 402, to generate heat on the surface of the electrode stack 218 at a particular temperature, such as 1000 centigrade. In another example, the laser generator 404 may be controlled 402 to pulse the laser beam 406 at a particular frequency and/or duration to generate the desired heat on the electrode stack 218. A speed and direction of movement of the laser generator 404 may also be controlled by the controller 402. In one example, a high-power (500 W) continuous wave fiber laser operating at a wavelength of 1060 nm may be utilized. In this manner, these and other aspects of the laser generator 404 and/or laser beam 406 may be optimized and/or controlled by the controller 402 to generate sufficient heat on the electrode to cut through the various layers of the stack.

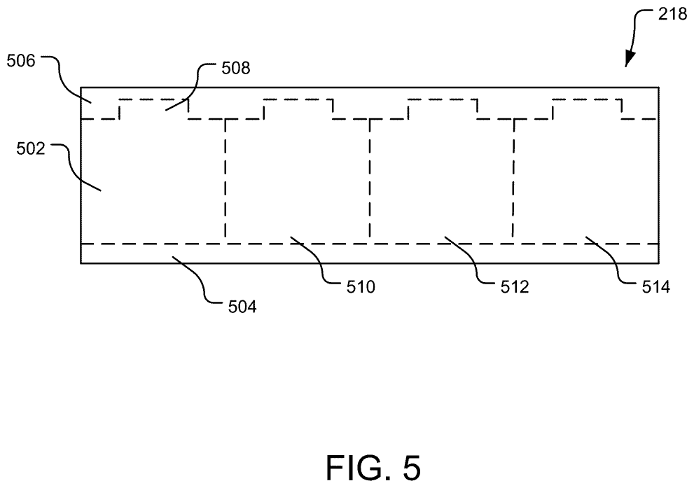

In some implementations, the laser cutter 220 may be programmed or otherwise controlled to produce a shaped electrode from the electrode stack 218. For example, FIG. 5 illustrates is a top view of an example electrode 218 cut from a solid-state electrode stack using a laser cutting device. In the example shown, the electrode stack 218 is cut along the dashed lines to obtain electrodes 502 that include a generally rectangular shape and a tab 508 portion extending from one side of the rectangle. When assembled in a battery cell, the rectangular body would be positioned with an electrolyte layer separating it from the opposing electrode or in some other configuration. In particular, the electrode stack 218, after calendaring, may be fed into the cutting device 220, which may include a laser to cut the stack along the dotted line to make a first electrode 414. The portion of the sheet outside the dotted lines forms the web or skeleton, i.e., the leftover portion of the electrode stack 218 after cutting.

In the instance illustrated in FIG. 5, the cutter 220 separates the electrode stack 218 into multiple portions. In particular, the electrode 218 may include a cut electrode portion 502, a first leftover or “skeleton” portion 504 along one edge of stack, and a second leftover portion 506 along a second edge of the stack. In the example shown, each cut electrode is immediately adjacent the next electrode. However, it possible that there will be some separation between electrodes thereby forming a lateral portion of the skeleton between each electrode and between the upper and lower portions of the skeleton. As mentioned, the shape and size of the electrode 502 may vary based on the battery configuration for which the cut electrode is to be used such that the shape of the skeleton portions 504, 506 may also vary in response to the different electrode shapes.

The laser cutter controller 402 may control movement of the laser generator 404, and thereby the laser beam 406, to cut the electrode stack 218 along the dotted lines illustrated in FIG. 5. In particular, the controller 402 may execute a program, or provide a directing program to the laser generator 404 for execution, to activate one or more actuators to move the laser generator 404 to cut the electrode stack 218 accordingly to a cut plan. Through this process, the electrode stack 218 may be cut into any shape for use in varying battery configurations and shapes. In another implementation, the controller 402 may be integrated into or with the laser generator 404 to execute the cut plan. In still another implementation, the laser generator 404 may remain stationary and the shape of the cut electrode may be created by moving the laser beam 406 along the cut plan.

In some instances, multiple electrodes may be cut from an electrode sheet in a continuous manner as the electrode sheet is fed through the laser cutter 220. For example, the electrode stack 218 may be fed into the laser cutter 220 and a first electrode 514 may be cut out of the stack. Following the cutting of the first electrode 514, the electrode stack 218 may be further fed into the laser cutter 220 and a second electrode 512 may be cut from the stack, followed by a third electrode 510, a fourth electrode 514, and so forth as the electrode stack 218 is fed through the laser cutter 220.

Returning to FIG. 4, the laser cutter system may also include a vacuum 408 to remove potential particles or other particles or other debris dislodged by the laser cutter during cutting. For example, the laser cutter 220 may, during cutting, cause metal particles or other particles to become dislodged from the layers of the electrode stack 218. As described above, these particles may adhere to and damage one or more of the layers of the stack 218. A vacuum 408 may therefore be situated near the cutting plane of the laser beam 406 to cause a suction pressure near the portion of the stack 218 being cut to remove loose material caused by the laser beam. In addition to removing debris, the suction pressure applied to the electrode stack 218 by the vacuum 408 may cause air flow at or near the portion of the stack being cut to cool or otherwise reduce the temperature of the layers of the stack at or around the cutting site to reduce the likelihood of burning or scorching of the electrode layers.

The vacuum 408 may be controlled by a vacuum controller 410 configured to adjust an amount of suction pressure of the vacuum. In some instances, the vacuum controller 410 may also move the vacuum 408 correspondingly with the laser beam generator 404 and/or laser beam 406 as the beam moves over the electrode stack 218. In still other implementations, the vacuum 408 and/or the vacuum controller 410 may be integrated with the laser generator 404 such that the laser generator and the vacuum are moved together to locate the suction pressure on the portion of the electrode stack 218 being cut.

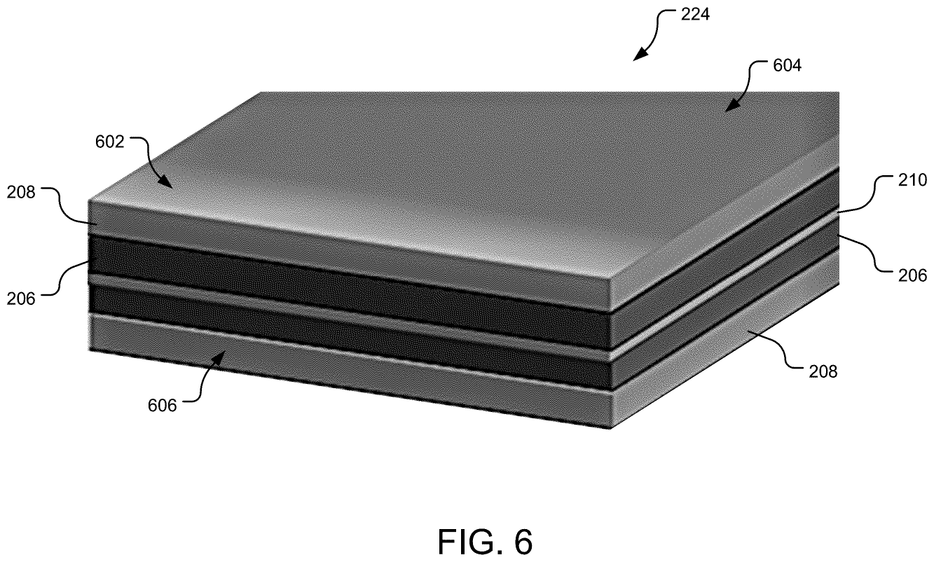

Through the use of the laser cutter 220 on the electrode stack 218, several additional advantages may also be attained. For example, the laser cutting may react with the chemicals of one or more of the layers to generate a fingerprint or other unique composition of chemicals within the electrode stack that may be used to identify the stack. As described above, the SSE layers 208 of the electrode stack 218 may contain a sulfide electrolyte that, when heated via the laser cutter 220, may decompose and release the sulfur component of the sulfide. This released sulfur may react with the other heated elements, such as an aluminum- or copper-based current collector 210, producing such materials as aluminum sulfide (Al₂S₃) or copper sulfide (CuS) at or near the cut edge of the stack 218. In addition, the sulfides generated from the super heating of the electrode stack 218 may fully or partially decompose into the respective oxides or hydroxides that may coat the newly cut surface. This coating may protect the cut edge of the electrode from reacting with ambient air or moisture that may degrade the conductive quality of the electrode edge. FIG. 6 is a diagram of a laser cut solid-state electrode 224 with a cauterized cut edge 606 with increased amount of oxygen near the laser cut edge. Similar to above, the electrode 224 may include a current collector layer 210 with two electrode layers 206 of a composite slurry blend coated onto both sides of the current collector. Further, two SSE layers 208 may be coated onto the outer surface of the electrode layers 206 in an SSE-Electrode-Current Collector-Electrode-SSE stack configuration. As also mentioned, other layer configurations may be cut through the laser cutting process described herein.

The electrode 224 of FIG. 6 includes an edge 606 that has been cut by a laser cutting device 220. Thus, the edge 606 may include a coating of oxides or hydroxides from the decomposed sulfides generated during the cutting process. In particular, the electrolyte layer 208 of the cut electrode stack 224 that is within close proximity of the heated cut areas due to the laser cutting may fully or partially decompose, while areas away from the heated cut may be less decomposed comparatively. Thus, the laser cutting may create a gradient of oxidized portions of the electrode stack that is highest in concentration at or near the cut edge of the electrode stack 224 toward the center of the piece. In one particular implementation, the oxygen incorporation into the electrolyte layer 208 may take the following form:

Li₆PS₅Cl→Li₆PS_{4.5}O_{0.5}Cl→Li₆PS₄OCl→Li₆PS_{3.5}O_{1.5}Cl→ . . .

from the center portion 604 of the electrolyte layer 208 toward the cut edge 602 of the layer. This is illustrated in FIG. 6 through the grayscale gradient along the electrolyte layer 208, with darker gray color representing portions with less oxygen concentration and lighter gray color representing portions with more oxygen concentration.

The higher concentration of oxygen at the cut edge 606 of the electrode stack 224 may generate a seal of the electrolyte layer 208 (and/or other layers of the stack) to prevent the layer from reacting to ambient air and moisture. The cauterized edge 606 may also prevent release of harmful particulates from the exposed layers. For example, hydrogen sulfide may be released from the electrolyte layer when cut by a mechanical cutting device, which may be harmful if inhaled. However, as the cutting laser super heats the electrolyte layer 208 to cut, oxidation of the cut edge may occur rapidly, reducing or eliminating any hydrogen sulfide that may be released into the air. The vacuum system 408 may operate to remove any released harmful particles, further increasing the safety of the laser cutting system in comparison to other cutting mechanisms.

This cauterization process may also generate a unique pattern or composition of such oxides and hydroxides of the electrode that is identifiable through a chemical mapping process to uniquely identify, or “fingerprint”, the electrode based on the chemical make-up of the electrode stack 224. This fingerprint of chemical make-up may also extend from the cut edge toward the center of the electrode. For example, the electrolyte material of the cut electrode stack 224 that is within close proximity of the heated cut areas due to the laser cutting may fully or partially decompose, while areas away from the heated cut may be less decomposed comparatively. In particular, cutting the material with the laser may cause a change in the crystal phase of the electrolyte material as it thermally decomposes, resulting in a gradient of not only oxidation, but also of electrolyte precursor or phase of electrolyte material. Some common electrolyte precursors may be Li2S, LiCl, LiBr, LiI, P2S5, which may also react with oxygen during the melting process resulting in oxygen containing analogs of these materials. Thus, the laser cutting may create a gradient of electrolyte phases from the cut edge of the electrode stack 224 toward the center of the piece that may further be unique to the particular electrode stack for identification purposes. In other instances, the cut edges of the cathode and anode layers of the electrode may not oxidized (e.g., contain Nickel Oxide (NiO), Aluminum Oxide (Al2O3), Manganese Oxide (MnO, MnO3, Mn2O3, Mn2O7, or Mn3O4), Cobalt Oxide (CoO, Co2O3, Co3O4), SiO2, or FeO2, but rather may contain Sulfur analogs (i.e. Nickel Sulfide, Aluminum Sulfide, Manganese Sulfide, Cobalt Sulfide, SiS2, and FeS2.

In yet another advantage, the laser cutting device 220 may maintain a flatter and straighter edge to the cut electrode than through mechanical cutting devices. As mentioned above, mechanical cutting devices may damage the cut edge through the pinching or shearing forces used to cut the electrode. As a result, many mechanically cut electrodes do not share cut edges to minimize the damage to one cut electrode instead of consecutive cut electrodes. However, the less-damaged and straighter cut edges of a laser cutting device 220 may allow electrodes to share cut edges, such as that illustrated in FIG. 5. Sharing cut edges between electrodes may reduce the waste byproduct between mechanically cut electrodes.

In another example, the laser cutting device 220 may be adjusted to etch some design into the surface of the electrode 224 without cutting through the layers. For example, a logo or unique identification code may be etched into the outer surface of the stacked electrode 224 using the laser beam 406. In such uses, the laser controller 402 may lessen the power or other aspect of the laser beam 406 so as to not cut through the layer and remove just an outer portion of the surface. In a similar manner, the laser cutting device 220 may be used to ablate one or more of the layers of the electrode stack 224. For example, prior to application of the electrode slurry to the current collector layer 210, the laser beam 406 may be used to ablate the surface of the current collector foil sheet to remove any impurities or oxidations from the surface of the foil. This may improve electrical communication between the current collector layer 210 and the electrode layer 206, in some instances. In this manner, the laser beam 406 may be used for multiple stages of the electrode production process in addition to cutting of the electrode stack into shapes.

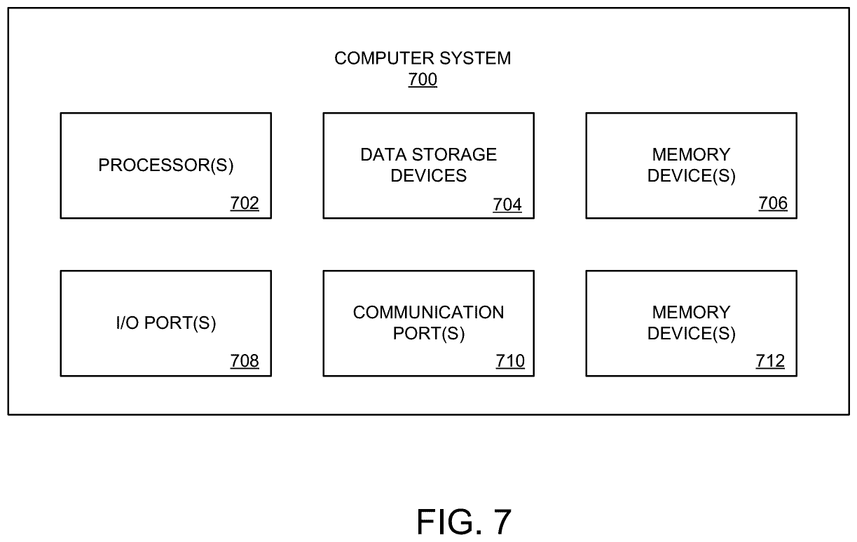

Referring to FIG. 7, a detailed description of an example computing system 700 having one or more computing units that may implement various systems and methods discussed herein is provided. The computing system 700 may be part of a controller, may be in operable communication with various implementation discussed herein, may run various operations related to the method discussed herein, and may be part of overall systems discussed herein. The computing system 700 may process various signals discussed herein and/or may provide various signals discussed herein. The computing system 700 may also be applicable to, for example, the laser controller and the vacuum controller discussed with respect to the various figures and may be used to implement the various methods described herein. It will be appreciated that specific implementations of these devices may be of differing possible specific computing architectures, not all of which are specifically discussed herein but will be understood by those of ordinary skill in the art. It will further be appreciated that the computer system may be considered and/or include an ASIC, FPGA, microcontroller, or other computing arrangement. In such various possible implementations, more or fewer components discussed below may be included, interconnections and other changes made, as will be understood by those of ordinary skill in the art.

The computer system 700 may be a computing system that is capable of executing a computer program product to execute a computer process. Data and program files may be input to the computer system 700, which reads the files and executes the programs therein. Some of the elements of the computer system 700 are shown in FIG. 7, including one or more hardware processors 702, one or more data storage devices 704, one or more memory devices 706, and/or one or more ports 708-712. Additionally, other elements that will be recognized by those skilled in the art may be included in the computing system 700 but are not explicitly depicted in FIG. 7 or discussed further herein. Various elements of the computer system 700 may communicate with one another by way of one or more communication buses, point-to-point communication paths, or other communication means not explicitly depicted in FIG. 7. Similarly, in various implementations, various elements disclosed in the system may or not be included in any given implementation.

The processor 702 may include, for example, a central processing unit (CPU), a microprocessor, a microcontroller, a digital signal processor (DSP), and/or one or more internal levels of cache. There may be one or more processors 702, such that the processor 702 comprises a single central-processing unit, or a plurality of processing units capable of executing instructions and performing operations in parallel with each other, commonly referred to as a parallel processing environment.

The presently described technology in various possible combinations may be implemented, at least in part, in software stored on the data stored device(s) 704, stored on the memory device(s) 706, and/or communicated via one or more of the ports 708-712, thereby transforming the computer system 700 in FIG. 7 to a special purpose machine for implementing the operations described herein.

The one or more data storage devices 704 may include any non-volatile data storage device capable of storing data generated or employed within the computing system 700, such as computer executable instructions for performing a computer process, which may include instructions of both application programs and an operating system (OS) that manages the various components of the computing system 700. The data storage devices 704 may include, without limitation, magnetic disk drives, optical disk drives, solid state drives (SSDs), flash drives, and the like. The data storage devices 704 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 706 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 704 and/or the memory devices 706, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computer system 700 includes one or more ports, such as an input/output (I/O) port 708, a communication port 710, and a sub-systems port 712, for communicating with other computing, network, or vehicle devices. It will be appreciated that the ports 708-712 may be combined or separate and that more or fewer ports may be included in the computer system 700. The I/O port 708 may be connected to an I/O device, or other device, by which information is input to or output from the computing system 700. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 700 via the I/O port 708. In some examples, such inputs may be distinct from the various system and method discussed with regard to the preceding figures. Similarly, the output devices may convert electrical signals received from computing system 700 via the I/O port 708 into signals that may be sensed or used by the various methods and system discussed herein. The input device may be an alphanumeric input device, including alphanumeric and other keys for communicating information and/or command selections to the processor 702 via the I/O port 708.

In one implementation, a communication port 710 may be connected to a network by way of which the computer system 700 may receive network data useful in executing the methods and systems set out herein as well as transmitting information and network configuration changes determined thereby. The communication port 710 connects the computer system 700 to one or more communication interface devices configured to transmit and/or receive information between the computing system 700 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 710 to communicate with one or more other machines, either directly over a point-to-point communication path, over a wide area network (WAN) (e.g., the Internet), over a local area network (LAN), over a cellular (e.g., third generation (3G), fourth generation (4G), fifth generation (5G)) network, or over another communication means.

The computer system 700 may include a sub-systems port 712 for communicating with one or more systems related to a device being charged according to the methods and system described herein to control an operation of the same and/or exchange information between the computer system 700 and one or more sub-systems of the device.

The system set forth in FIG. 7 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be utilized.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Embodiments of the present disclosure include various operations, which also may be referred to as steps, which are described in this specification. The operations may be performed by or involve hardware components or may be embodied in machine-executable instructions, which may be used to cause a general-purpose or special-purpose processor programmed with the instructions to perform the operations. Alternatively, the operations may be performed by a combination of hardware, software and/or firmware.

Although various representative embodiments of this invention have been described above with a certain degree of particularity, those skilled in the art could make numerous alterations to the disclosed embodiments without departing from the spirit or scope of the inventive subject matter set forth in the specification. All directional references (e.g., upper, lower, upward, downward, left, right, leftward, rightward, top, bottom, above, below, vertical, horizontal, clockwise, and counterclockwise) are only used for identification purposes to aid the reader's understanding of the embodiments of the present invention, and do not create limitations, particularly as to the position, orientation, or use of the invention unless specifically set forth in the claims. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected to another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present disclosure.

While specific embodiments are discussed, it should be understood that this is done for illustration purposes only. A person skilled in the relevant art will recognize that other components and configurations may be used without parting from the spirit and scope of the disclosure. Thus, the above description and drawings are illustrative and are not to be construed as limiting. Numerous specific details are described to provide a thorough understanding of the disclosure. However, in certain instances, well-known or conventional details are not described in order to avoid obscuring the description.

Reference to “one embodiment” or “an embodiment” means that a particular feature, structure, or characteristic described in connection with the embodiment is included in at least one embodiment of the disclosure. The appearances of the phrase “in one embodiment”, or similarly and synonymously “in one example” or “in one instance”, in various places in the specification are not necessarily all referring to the same embodiment, nor are separate or alternative embodiments mutually exclusive of other embodiments. Moreover, various features are described which may be exhibited by some embodiments and not by others. The disclosure is not limited to various embodiments (examples, instances or aspects) given in this specification. Various modifications and additions can be made to the exemplary embodiments discussed without departing from the scope of the present invention. Accordingly, the scope of the present invention is intended to embrace all such alternatives, modifications, and variations together and in various possible combinations of various different features of different embodiments combined to form yet additional alternative embodiments, with all equivalents thereof.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term.

Without intent to limit the scope of the disclosure, examples of instruments, apparatus, methods and their related results according to the embodiments of the present disclosure are given. Note that titles or subtitles may be used in the various embodiments for convenience of a reader, which in no way should limit the scope of the disclosure.

Various features and advantages of the disclosure are set forth in the description above, and in part will be obvious from the description, or can be learned by practice of the herein disclosed principles. The features and advantages of the disclosure can be realized and obtained by means of the instruments and combinations particularly pointed out in the appended claims.

We claim:

1. A method for cutting a battery electrode, the method comprising:
laminating an electrode stack comprising a plurality of layers using a pressing device, wherein the pressing device laminates a solid-state electrolyte (SSE)-containing layer to a conductive foil; and
removing, using a laser cutting device, a portion of the electrode stack.

2. The method of claim 1, wherein the laser cutting device melts a plurality of components of the plurality of layers of the electrode stack to remove the portion from the electrode stack.

3. The method of claim 2, wherein melting the SSE-containing layer causes oxidation of the SSE-containing layer along a cut edge of the portion of the electrode stack.

4. The method of claim 3, wherein the oxidation of the SSE-containing layer along the cut edge of the portion of the electrode stack reduces a reaction of the SSE-containing layer to ambient moisture.

5. The method of claim 3, wherein the electrode stack comprises a higher concentration of oxidation at the cut edge of the portion of the electrode stack than a middle portion of the electrode stack.

6. The method of claim 1 further comprising:
controlling a position of the laser cutting device to remove a shaped portion of the electrode stack.

7. The method of claim 1 further comprising:
controlling an energy profile of a laser beam generated from the laser cutting device, the energy profile comprising at least one of a temperature of the laser beam, a position of the laser beam, or a pulse frequency of the laser beam.

8. The method of claim 1 further comprising:
removing, using a vacuuming device, a byproduct of the electrode stack caused by the removing of the portion of the electrode stack.

9. The method of claim 8, wherein the vacuuming device further reduces a temperature of the portion of the electrode stack.

10. The method of claim 1, wherein the electrode stack comprises at least one SSE layer, an upper electrode layer, the conductive foil, and a lower electrode layer.

11. The method of claim 1, wherein the pressing device is a calendar press comprising a first roller and a second roller, the first roller oriented above the second roller and separated by a pressing gap.

12. The method of claim 1, wherein removing the portion of the electrode stack comprises cutting through the plurality of layers of the electrode stack to generate a defined shape of an electrode from the electrode stack.

13. A system for manufacturing an electrode of a battery, the system comprising:
a pressing device laminating an electrode stack comprising a solid-state electrolyte (SSE)-containing layer and a conductive foil; and
a laser cutting device producing a laser beam to cut a portion of the electrode stack into a shaped electrode for the battery.

14. The system of claim 13, wherein the laser cutting device melts a plurality of components of the SSE-containing layer and the conductive foil to remove the portion from the electrode stack.

15. The system of claim 14, wherein melting the SSE-containing layer causes oxidation of the SSE-containing layer along a cut edge of the portion of the electrode stack.

16. The system of claim 15, wherein the oxidation of the SSE-containing layer along the cut edge of the portion of the electrode stack reduces a reaction of the SSE-containing layer to ambient moisture.

17. The system of claim 13 further comprising:
a controller in communication with the laser cutting device controlling a position of the laser cutting device to remove a shaped portion of the electrode stack.

18. The system of claim 17, wherein the controller further controls an energy profile of the laser beam generated from the laser cutting device, the energy profile comprising at least one of a temperature of the laser beam, a position of the laser beam, or a pulse frequency of the laser beam.

19. The system of claim 13 further comprising:
a vacuuming device removing a byproduct of the electrode stack caused by the removing of the portion of the electrode stack.

20. The system of claim 13, wherein the electrode stack comprises at least one SSE layer, an upper electrode layer, the conductive foil, and a lower electrode layer.
